(19) United States
(12) Patent Application Publication
(10) Pub. No.: US 2026/0100027 A1
(43) Pub. Date: Apr. 9, 2026

(54) METHOD AND APPARATUS FOR TRAINING AN OBJECT RECOGNITION MODEL

(71) Applicants: HYUNDAI MOTOR COMPANY, Seoul (KR); KIA CORPORATION, Seoul (KR)

(72) Inventor: Young Hyun Kim, Hwaseong-si (KR)

(73) Assignees: HYUNDAI MOTOR COMPANY, Seoul (KR); KIA CORPORATION, Seoul (KR)

(21) Appl. No.: 19/228,098

(22) Filed: Jun. 4, 2025

(30) Foreign Application Priority Data
Oct. 8, 2024 (KR) 10-2024-0137122

(51) Int. Cl. G06V 10/778

(52) U.S. Cl. CPC G06V 10/778

(57) ABSTRACT

A method for training an object recognition model includes receiving training data. The method also includes training the object recognition model using a loss function that includes a first loss function for a class score of an object and a first weight function for reflecting confidence for the class score of the object and the training data.

### CROSS-REFERENCE TO RELATED APPLICATION

This application claims the benefit of and priority to Korean Patent Application No. 10-2024-0137122, filed in the Korean Intellectual Property Office on Oct. 8, 2024, the entire contents of which are hereby incorporated herein by reference.

### TECHNICAL FIELD

The present disclosure relates to technologies for training an object recognition model. More particularly, the present disclosure relates to a method and an apparatus for training an object recognition model to reflect confidence for a class score of an object in a loss function to train the object recognition model.

### BACKGROUND

A deep learning technology is one of technologies of machine learning. Machine learning generally refers to a technology for designing a structure in a similar manner to the way humans think and continuously analyzing and processing data. Since the 1990s, several models have been discussed. With the improvement of hardware performance and the increase in computing power, the deep learning technology has been advanced and developed.

Among fields in which deep learning technology is actively used is the field of image recognition and object classification. In this field, deep learning technology is developed to recognize an object in an image and quickly and efficiently determine whether to classify the object as any particular object.

As an example, a deep learning model includes a convolutional neural network (CNN), a You only looks once (YOLO) model, or the like. YOLO refers to a deep-learning-based algorithm capable of looking at an image once and estimating a location of an object.

The statements in this Background section merely provide background information related to the present disclosure and may not constitute prior art.

### SUMMARY

The present disclosure has been made to solve the above-mentioned problems occurring in the prior art while advantages achieved by the prior art are maintained intact.

Aspects of the present disclosure provide a method and an apparatus for training an object recognition model to reflect confidence for a class score of an object in a loss function to train the object recognition model.

Other aspects of the present disclosure provide a method and an apparatus for training an object recognition model to train the object recognition model using a loss function in which confidence for a class score of an object is reflected and improve the accuracy of object recognition using the trained object recognition model.

Further aspects of the present disclosure provide a method and an apparatus for training an object recognition model to train the object recognition model using a loss function in which confidence for a 3D location of an object is reflected to improve the accuracy of location for distance.

The technical problems to be solved by the present disclosure are not limited to the aforementioned problems. Other technical problems not mentioned herein should be more clearly understood the following description by those having ordinary skill in the art to which the present disclosure pertains.

According to an aspect of the present disclosure, a method for training an object recognition model is provided. The method includes receiving training data. The method also includes training the object recognition model using a loss function that includes a first loss function for a class score of an object and a first weight function for reflecting confidence for the class score of the object and the training data.

According to an embodiment, the first weight function may be configured to increase a loss value of the loss function based on a determination that the class score of the object by the first loss function is a uniform distribution (i.e., uniformly distributed). The first weight function may also be configured to decrease the loss value of the loss function based on a determination that a class that is wrong for the object (i.e., a wrong class) satisfies a predetermined probability criterion.

According to an embodiment, the loss function may include a sum of the first loss function and the first weight function.

According to an embodiment, the first weight function may be represented as Equation below.

$$The first weight function = ( 1 + {L}_{se} ) \cdot ( 1 - {L}_{cer} )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

wherein Pᵢ refers to an output value of the object recognition model for all classes of a target object, wᵢ refers to a predetermined weight, and C_{gt} refers to a ground-truth class. here, Pᵢ refers to an output value of the object recognition model for all classes of a target object, wᵢ refers to a predetermined weight, and C_{gt} refers to a ground-truth class.

According to an embodiment, the loss function may further include a second loss function for a three-dimensional (3D) location of the object and a second weight function for reflecting confidence for the 3D location of the object.

According to an embodiment, the loss function may include a sum of the second weight function and the second loss function represented as Equation below.

$$The second weight function = ( {L}_{uc \_ xz} + {L}_{uc \_ vl} + {L}_{uc \_ a} )$$

$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$

$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$

$${D}_{pg} = \frac{1}{1 + exp ( - ( p - g ) )}$$

$$U = ( ( 1 + {L}_{se} ) \cdot ( 1 - {L}_{cer} ) )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

$${N}_{max} = max ( 1 , N ( {D}_{pg} \vert 0.5 , U ) )$$

wherein Pᵢ refers to an output value of the object recognition model for all classes of a target object, wᵢ refers to a predetermined weight, C_{gt} refers to a ground-truth class, p (x) and p (z) refer to an estimated x-coordinate value and an estimated z-coordinate value of the object, respectively, g (x) and g (z) refer to a ground-truth x-coordinate value and a ground-truth z-coordinate value of the object, respectively, p (l) and p (a) refer to an estimated volume value and an estimated heading angle of the object, respectively, and g (1) and g (a) refer to a ground-truth volume value and a ground-truth heading angle of the object, respectively.

According to another aspect of the present disclosure, an object recognition method is provided. The object recognition method includes receiving an input image. The object recognition method also includes recognizing at least one object included in the input image using an object recognition model trained by a loss function that includes a first loss function for a class score of an object and a first weight function for reflecting confidence for the class score of the object.

According to an embodiment, the first weight function may increase a loss value of the loss function based on a determination that the class score of the object by the first loss function is a uniform distribution. The loss function may also be configured to decrease the loss value of the loss function based on a determination that a class wrong for the object satisfies a predetermined probability criterion.

According to an embodiment, the first weight function may be represented as Equation below.

$$The first weight function = ( 1 + {L}_{se} ) \cdot ( 1 - {L}_{cer} )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

wherein Pᵢ refers to an output value of the object recognition model for all classes of a target object, wᵢ refers to a predetermined weight, and C_{gt} refers to a ground-truth class.

According to an embodiment, the loss function may further include a second loss function for a 3D location of the object and a second weight function for reflecting confidence for the 3D location of the object.

According to an embodiment, the loss function may include a sum of the second weight function and the second loss function as represented by Equation below.

$$The second weight function = ( {L}_{uc \_ xz} + {L}_{uc \_ vl} + {L}_{uc \_ a} )$$

$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$

$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$

$${D}_{pg} = \frac{1}{1 + exp ( - ( p - g ) )}$$

$$U = ( ( 1 + {L}_{se} ) \cdot ( 1 - {L}_{cer} ) )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

$${N}_{max} = max ( 1 , N ( {D}_{pg} \vert 0.5 , U ) )$$

wherein Pᵢ refers to an output value of the object recognition model for all classes of a target object, wᵢ refers to a predetermined weight, C_{gt} refers to a ground-truth class, p (x) and p (z) refer to an estimated x-coordinate value and an estimated z-coordinate value of the object, respectively, g (x) and g (z) refer to a ground-truth x-coordinate value and a ground-truth z-coordinate value of the object, respectively, p (l) and p (a) refer to an estimated volume value and an estimated heading angle of the object, respectively, and g (1) and g (a) refer to a ground-truth volume value and a ground-truth heading angle of the object, respectively.

According to yet another aspect of the present disclosure, an apparatus for training an object recognition model is provided. The apparatus includes a memory storing computer-readable instructions and at least one processor coupled to the memory and configured to execute the computer-readable instructions. The at least one processor is configured to receive training data. The at least one processor is also configured to train the object recognition model using a loss function that includes a first loss function for a class score of an object and a first weight function for reflecting confidence for the class score of the object and the training data.

According to an embodiment, the first weight function may be configured to increase a loss value of the loss function based on a determination that the class score of the object by the first loss function is a uniform distribution. The first weight function may also be configured to decrease the loss value of the loss function based on a determination that a class wrong for the object satisfies a predetermined probability criterion.

According to an embodiment, the loss function may include a sum of the first loss function and the first weight function.

According to an embodiment, the first weight function may be represented as Equation below.

$$The first weight function = ( 1 + {L}_{se} ) \cdot ( 1 - {L}_{cer} )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

wherein Pᵢ refers to an output value of the object recognition model for all classes of a target object, wᵢ refers to a predetermined weight, and C_{gt} refers to a ground-truth class.

According to an embodiment, the loss function may further include a second loss function for a 3D location of the object and a second weight function for reflecting confidence for the 3D location of the object.

According to an embodiment, the loss function may include a sum of the second weight function and the second loss function as represented by Equation below.

$$The second weight function = ( {L}_{uc \_ xz} + {L}_{uc \_ vl} + {L}_{uc \_ a} )$$

$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$

$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$

$${D}_{pg} = \frac{1}{1 + exp ( - ( p - g ) )}$$

$$U = ( ( 1 + {L}_{se} ) \cdot ( 1 - {L}_{cer} ) )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

$${N}_{max} = max ( 1 , N ( {D}_{pg} \vert 0.5 , U ) )$$

wherein Pᵢ refers to an output value of the object recognition model for all classes of a target object, wᵢ refers to a predetermined weight, C_{gt} refers to a ground-truth class, p (x) and p (z) refer to an estimated x-coordinate value and an estimated z-coordinate value of the object, respectively, g (x) and g (z) refer to a ground-truth x-coordinate value and a ground-truth z-coordinate value of the object, respectively, p (1) and p (a) refer to an estimated volume value and an estimated heading angle of the object, respectively, and g (1) and g (a) refer to a ground-truth volume value and a ground-truth heading angle of the object, respectively.

The features briefly summarized above with respect to the present disclosure are merely illustrative aspects of the detailed description of the present disclosure and do not limit the scope of the present disclosure.

### BRIEF DESCRIPTION OF THE DRAWINGS

The above and other objects, features, and advantages of the present disclosure should be more apparent from the following detailed description taken in conjunction with the accompanying drawings, in which:

FIG. 1 illustrates an operational flowchart for a method for training an object recognition model according to an embodiment of the present disclosure;

FIG. 2 illustrates an example for a weight function used in a method of the present disclosure;

FIG. 3 illustrates an example for describing a problem capable of being generated by a Shannon entropy function;

FIG. 4 illustrates an example for describing the result of recognition through an object recognition model trained by an embodiment of the present disclosure;

FIG. 5 illustrates an operational flowchart for an object recognition method according to another embodiment of the present disclosure;

FIG. 6 illustrates a configuration of an apparatus for training an object recognition model according to another embodiment of the present disclosure; and

FIG. 7 illustrates a block diagram of a computing system for executing a method for training an object recognition model according to an embodiment of the present disclosure.

### DETAILED DESCRIPTION

Hereinafter, embodiments of the present disclosure are described in detail with reference to the accompanying drawings to enable one of ordinary skill in the art to implement the present disclosure. However, the present disclosure may be embodied in many different forms and should not be construed as being limited to the embodiment set forth herein.

In describing embodiments of the present disclosure, where it was determined that a detailed description of a well-known configuration or function may obscure the gist of the present disclosure, the detailed description thereof has been omitted. Parts not related to the description of the present disclosure are omitted in the drawings, and same or similar parts are denoted by same or similar reference numerals throughout the specification.

In the present disclosure, when a component is referred to as being “connected with” or “coupled to” another component, it includes not only a case where the component is directly connected to the other component but also a case where the component is indirectly connected with the other component and there are other one or more components in between. In addition, when one component is referred to as “comprising”, “including”, “having”, or the like, another component, it is meant that the component may further include other components without excluding other components as long as there is no contrary description in the present disclosure.

In the present disclosure, the terms such as “first” and “second” are used only for the purpose of distinguishing one component from another. Such terms do not limit an order, the importance, or the like of components unless specifically stated herein. Thus, a first component in an embodiment may be referred to as a second component in another embodiment in the scope of the present disclosure. Likewise, a second component in an embodiment may be referred to as a first component in another embodiment.

In the present disclosure, components that are distinguished from each other are only for clearly explaining each feature, and do not necessarily mean that the components are separated. For example, a plurality of components may be integrated to form a single hardware or software unit, or a single component may be distributed to form a plurality of hardware or software units. Thus, even if not specifically mentioned, the integrated or separate embodiments are also included in the scope of the present disclosure.

In the present disclosure, components described in various embodiments may not necessarily refer to essential components, and some of the components may be non-essential components. Thus, an embodiment composed of a subset of components described in an embodiment is also included in the scope of the present disclosure. Also, an embodiment that includes one or more other components in addition to the components described in various embodiments are also included in the scope of the present disclosure.

In the present disclosure, expressions of positional relationships used in the specification, for example, top, bottom, left, and right, are described for convenience of description. When viewing the drawings illustrated in the specification in reverse, the positional relationship described in the specification may be interpreted in the opposite way.

In the present disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, and the like may separately embody or be included with a processor and a memory, such as a non-transitory computer readable media, as part of the apparatus.

As used herein, a blind-spot view camera object detector uses logic that is composed of a deep neural network (DNN) and is particularly composed of a convolutional neural network (CNN), in various embodiments.

The blind-spot view camera object detector may output two-dimensional (2D) information, three-dimensional (3D) information, and class information, in various embodiments.

The 2D information may be bounding box information of an object in an image, which may include b_{2D} (Xmin, Ymin, Xmax, Ymax).

The 3D information may be object information on a 3D coordinate system, which may include b_{3D}(b_{3D1}, b_{3Dv}, b_{3Da}). Herein, b_{3D1} may refer to a 3D location, X, Y, and Z, of the object, b_{3Dv} may refer to a height, a width, and a length for the volume of the object, and b_{3Da} may refer to a heading angle of the object.

The class information may be information referring to a type of the detected object.

A conventional loss function for object detection may include a loss function L_{C} for an object class (or type), a loss function L_{2D} for a 2D location of the object on an image, and a loss function L_{3D} for a 3D location of the object on the image, which may be represented as Equation 1 below.

$${L}_{C} = - log ( \frac{exp ( {P}_{c} )}{{\sum }_{i}^{N} exp ( {P}_{c} )} ) \qquad [ Equation 1 ]$$

$${L}_{2 D} = - log ( IoU ( {b}_{2 D}^{pred} , {b}_{2 D}^{GT} ) )$$

$${L}_{3 D} = {SmoothL}_{1} ( {b}_{3 Dl}^{pred} , {b}_{3 Dl}^{GT} ) + {SmoothL}_{1} ( {b}_{3 Dv}^{pred} , {b}_{3 Dv}^{GT} ) + {SmoothL}_{1} ( {b}_{3 Da}^{pred} , {b}_{3 Da}^{GT} )$$

Herein, Pᵢ may refer to the output value of an object recognition model, for example, a DNN for all classes of the target object. P_{C} may refer to the output value of the object recognition model, for example, the DNN for the ground-truth class of the target object. IoU may refer to Intersection over Union. b_{2D}^{pred} and b_{2D}^{GT} may refer to the 2D estimation location and the 2D ground-truth location of the object, respectively. b_{3D1}^{pred} and b_{3D1}^{GT} may refer to the 3D estimation location and the 3D ground-truth location of the object, respectively. b_{3Dv}^{pred} and b_{3Dv}^{GT} may refer to the 3D estimation volume and the 3D ground-truth volume of the object, respectively. b_{3Da}^{pred} and b_{3Da}^{GT} may refer to the 3D estimation heading angle and the 3D ground-truth heading angle of the object, respectively. The output value of the DNN may be a value before being converted into a probability value.

However, the conventional loss function for object detection has a problem of being incapable of determining uncertainty for each output. Particularly, the loss function L_{C} for the object class has a problem of only learning a probability of a class and not guiding to accurately learn reliability (or confidence) of the detected object.

A conventional technology for addressing this problem trains an object recognition model using an uncertainty-based loss function.

Because the conventional technology is unable to determine whether a value estimated by learning the bounding box coordinates value itself is accurate, the conventional technology typically adds a reliability portion of each coordinate value to improve the estimated value and determines how reliable the estimated value is. Generally, the conventional technology determines whether a difference between the estimated value and a real value increases as the reliability of the bounding box coordinates decreases to regard the estimated value as a false positive.

The conventional technology adds confidence as a separate output to the DNN although there is an object/class score capable of representing confidence already. The loss function allows the DNN to estimate the confidence for each item of the bounding box coordinates. The conventional technology combines them to calculate the entire reliability, but has a problem in that the technology is incapable ensuring that confidence of the recognized object itself is represented because the conventional technology utilizes the confidence for each location item.

Embodiments of the present disclosure include confidence of a recognized object in a probability value estimated for an object class, thereby improving the accuracy of object recognition.

Embodiments of the present disclosure reflect confidence for a class score of an object in a loss function to train an object recognition model, thereby improving the accuracy of object recognition using the trained object recognition model.

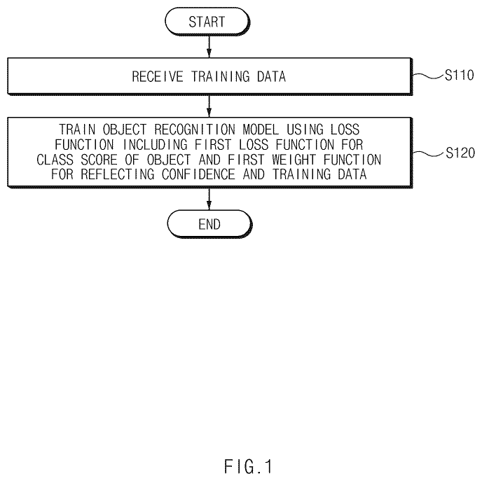

FIG. 1 illustrates an operational flowchart for a method for training an object recognition model according to an embodiment of the present disclosure.

Referring to FIG. 1, the method for training the object recognition model according to an embodiment of the present disclosure may include a step or operation S110 of receiving training data for training the object recognition model. The method may also include a step or operation S120 of training the object recognition model using a loss function that includes a first loss function for a class score of an object and a first weight function for reflecting confidence for the class score of the object and the training data.

Herein, the first loss function may be a loss function L_{C} for an object class (or type) in Equation 1 above. However, the first loss function is not restricted or limited to the loss function for the object class in Equation 1 above and may include other types of loss functions available in the object recognition model.

The first weight function may be a function to explicitly assign a weight to a condition the first loss function does not represent.

The condition the first loss function does not represent may be as follows.
(A) When a class score Pᵢ of each object is uniformly distributed, a DNN may regard that it is not sure of a class of the object when determining the class of the object and may confuse the class of the object and another class. The DNN may determine that output confidence of the DNN is lowered. Thus, when the class score shows a uniform distribution, a loss value should increase to a certain value or more. Herein, the case in which the class score Pᵢ of each object is uniformly distributed may include a case in which output values of the object recognition model for all classes of the target object are uniformly distributed.
(B) When the DNN estimates a wrong class as a high score, the class score shows a non-uniform distribution, but there is a need to correct a loss value for the wrong class because of estimating the wrong class. Thus, when estimating the wrong class, the loss value should increase to the certain value or more. In other words, when estimating the wrong class as a high score (or a high probability value), it should be supplemented such that the loss value of the loss function according to an embodiment of the present disclosure decreases to the certain value or less.
(C) Because the first loss function includes a loss for item (B), but is not linked to item (A) and is composed of a separate item, there is a weight capable of being linked to item (A).

In other words, the first weight function may be a function for supplementing that the first loss function does not represent confidence of a recognition object or a recognition target. The first weight function may increase a loss value of a loss function to a first value or more based on a determination that the class score of each object by the first loss function is a uniform distribution. Further, the first weight function may decrease the loss value of the loss function to a second value or less based on a determination that a class wrong for the object satisfies a predetermined probability criterion (e.g., is a predetermined first probability or more.)

Such a first weight function may be added to the first loss function to reflect confidence for the class score of the object. Accordingly, the loss function may include a sum of the first loss function and the first weight function.

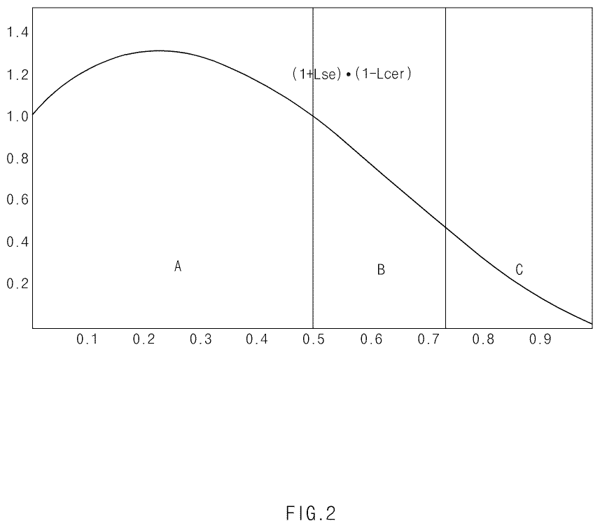

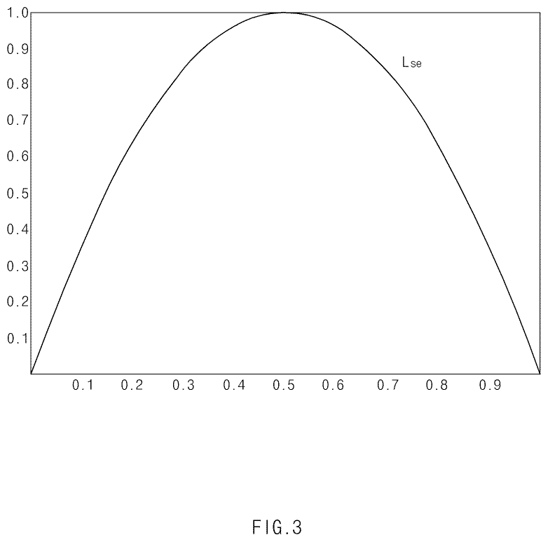

The first weight function, according to an embodiment, is described in more detail below with reference to FIGS. 2 and 3.

FIG. 2 illustrates an example for a weight function used in a method of the present disclosure, according to an embodiment. FIG. 3 illustrates an example for describing a problem capable of being generated by a Shannon entropy function, according to an embodiment.

As described above, the loss function for the class score of the object in the method according to an embodiment of the present disclosure may be represented in the form in which the first loss function and the first weight function are added together and may be represented as Equation 2 below, in an embodiment.

$${L}_{C} = - log ( \frac{exp ( {P}_{c} )}{{\sum }_{i}^{N} exp ( {P}_{c} )} ) + ( ( 1 + {L}_{se} ) \cdot ( 1 - {L}_{cer} ) ) \qquad [ Equation 2 ]$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

Herein, the first weight function may refer to ((1+Lₛₑ)·(1-L_{cer})), Pᵢ may refer to the output value of the object recognition model for all classes of the target object, wᵢ may refer to the predetermined weight, and C_{gt} may refer to the ground-truth class.

According to an embodiment, the first weight function may be represented as the Shannon entropy (1+Lₛₑ) and the class score weight (1-L_{cer}).

As shown in FIG. 2, the first weight function may be divided into area A, area B, and area C. Area A is an area with a large loss value, when class estimation is wrong and a class score is uniformly distributed. Area B is an area with a somewhat high loss value, when the class estimation is good, but the class score is uniformly distributed. Area C is an area with a small loss value, when the class estimation is good and the class score is a non-uniform distribution.

As shown in FIG. 3, when only Lₛₑ is used as the first weight function, the loss function may be maximized when each class score is a uniform distribution, a total loss value may be lowered when a wrong class is determined as a high probability, and training of the object recognition model may be wrong due to it. Thus, the method according to an embodiment of the present disclosure may multiply the Shannon entropy (1+Lₛₑ) by the class score weight (1-L_{cer}) to correct or supplement such a problem, thus correcting or supplementing a problem capable of being generated by the Shannon entropy.

The loss function for the class score of the object in a method according to an embodiment of the present disclosure may be an uncertainty loss function in which confidence for the class score of the object is reflected.

In addition, the method for training the object recognition model according to an embodiment of the present disclosure may learn a confidence-based 3D location value that is not included in a conventional loss function for a 3D location of the object, such as the loss function for the 3D location of the object in Equation 1 above.

According to an embodiment, the loss function for the 3D location of the object used in a method of the present disclosure may include a second loss function for the 3D location of the object and a second weight function for reflecting confidence for the 3D of the object. Herein, the second loss function may refer to a loss function for the 3D location of the object in Equation 1 above. However, the second loss function is not restricted or limited to the loss function for the 3D location of the object in Equation 1 above and may include other types of loss functions available in the object recognition model.

The loss function for the 3D location of the object used in the method of the present disclosure considers the following consideration.
(A) Although a difference between a ground-truth (GT) value b_{3D}^{GT} for a real location/volume/angle of a recognition target and a value by_{3D}^{pred} estimated by a DNN is small, when confidence for the recognition target is low, it may not be possible to be sure whether the DNN accurately estimates and outputs the value b3Dpred or obtains the GT value b3DGT by accident. Thus, the loss function of the localization value should also be linked to output reliability of the recognition target.
(B) A weight for an error of a localization value is previously linked to distance, but this may be the cause of rather degrading the accuracy of location for a remote distance. Thus, the loss function of the localization value should also be linked to output reliability for distance.

In an embodiment, the loss function for the 3D location of the object in the method according to an embodiment of the present disclosure may be represented in the form in which the second loss function and the second weight function are added together and be represented as Equation 3 below, in an embodiment. The loss function may thus include a sum of the second loss function and the second weight function.

$${L}_{3 D \_ proposed} = {SmoothL}_{1} ( {b}_{3 Dl}^{pred} , {b}_{3 Dl}^{GT} ) + {SmoothL}_{1} ( {b}_{3 Dv}^{pred} , {b}_{3 Dv}^{GT} ) + {SmoothL}_{1} ( {b}_{3 Da}^{pred} , {b}_{3 Da}^{GT} ) + ( {L}_{uc \_ xz} + {L}_{uc \_ vl} + {L}_{uc \_ a} ) \qquad [ Equation 3 ]$$

$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$

$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$

$${D}_{pg} = \frac{1}{1 + exp ( - ( p - g ) )}$$

$$U = ( ( 1 + {L}_{se} ) \cdot ( 1 - {L}_{cer} ) )$$

$${L}_{se} = - {\sum }_{i = 1}^{n} ( {P}_{i} \cdot {log}_{2} {P}_{i} )$$

$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$

$${N}_{max} = max ( 1 , N ( {D}_{pg} \vert 0.5 , U ) )$$

Herein, the second weight function may refer to (L_{uc_xz}+L_{uc_vl}+L_{uc_a}),

$${SmoothL}_{1} ( {b}_{3 Dl}^{pred} , {b}_{3 Dl}^{GT} ) + {SmoothL}_{1} ( {b}_{3 Dv}^{pred} , {b}_{3 Dv}^{GT} ) + {SmoothL}_{1} ( {b}_{3 Da}^{pred} , {b}_{3 Da}^{GT} )$$

may be the second loss function, which may refer to the loss function for the 3D location of the object in Equation 1 above, p (x) and p (z) may refer to the estimated x-coordinate value and the estimated z-coordinate value of the object, respectively, g (x) and g (z) may refer to the ground-truth x-coordinate value and the ground-truth z-coordinate value of the object, respectively, p(l) and p (a) may refer to the estimated volume value and the estimated heading angle of the object, respectively, and g(l) and g (a) may refer to the ground-truth volume value and the ground-truth heading angle of the object, respectively.

In Equation 3 above, U may redefine uncertainty, N (D_{pg}| 0.5, U) may define the probability density function, and Nₘₐₓ may be the value for performing normalization for an extremely small variance.

The loss function for the 3D location of the object in the method according to an embodiment of the present disclosure may be an uncertainty loss function in which confidence for the class score of the object is reflected.

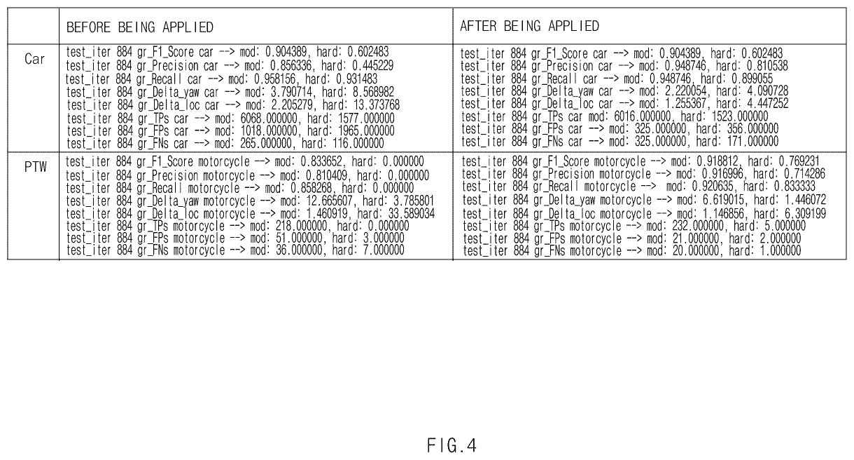

FIG. 4 illustrates an example for describing the result of recognition through an object recognition model trained by an embodiment of the present disclosure. As shown in FIG. 4, it may be seen that an object recognition ratio after a method according to an embodiment of the present disclosure is applied may be improved as compared to an object recognition ratio before the method according to an embodiment of the present disclosure is applied.

As such, a method for training an object recognition model according to embodiments of the present disclosure may reflect confidence for a class score of an object in a loss function to train the object recognition model.

Furthermore, a method for training the object recognition model according to embodiments of the present disclosure may train the object recognition model using the loss function in which the confidence for the class score of the object is reflected, thus improving the accuracy of object recognition using the trained object recognition model. In other words, the method for training the object recognition model according to embodiments of the present disclosure may provide a guide to well train the object recognition model by being implemented to include uncertainty for a confidence-based class in the loss function and including a confidence-based weight function in the loss function to train the object recognition model.

Furthermore, a method for training the object recognition model according to embodiments of the present disclosure may train the object recognition model using the loss function in which the confidence for the 3D location of the object is reflected, thus improving the accuracy of location for distance.

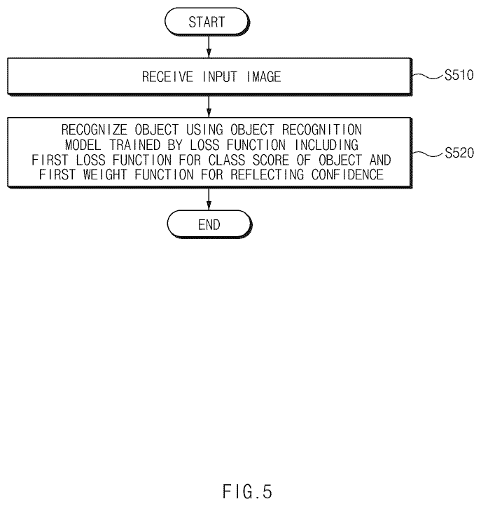

FIG. 5 illustrates an operational flowchart for an object recognition method according to another embodiment of the present disclosure. FIG. 5 illustrates an operational flowchart for a process of recognizing an object from an input image received in real time using the object recognition model trained by the method of FIGS. 1-4.

Referring to FIG. 5, the object recognition method according to another embodiment of the present disclosure may include a step or operation S510 of receiving an image (or an input image) captured in real time by an image capture means, for example, a camera sensor. The method may also include a step or operation S520 of recognizing at least one object included in the input image using an object recognition model trained by a loss function including a first loss function for a class score of an object and a first weight function for reflecting confidence for the class score of the object.

According to an embodiment, the object recognition model may be trained through the loss function for the class score of the object in Equation 2 described above and may additionally trained by further including a loss function for a 3D location of the object in Equation 3 described above.

In other words, the object recognition method of the present disclosure may recognize an object from the image input in real time using the object recognition model trained by a method for training the object recognition model according to an embodiment of the present disclosure to accurately recognize the object, thus preventing a problem which may be generated by an object recognition error during vehicle operation.

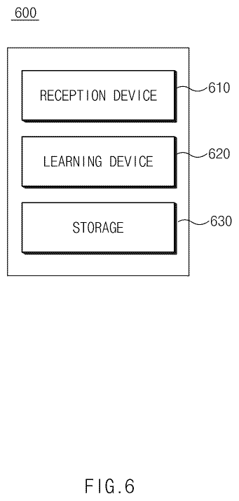

FIG. 6 illustrates a configuration of an apparatus for training an object recognition model according to another embodiment of the present disclosure. FIG. 6 illustrates a conceptual configuration block diagram for an apparatus for performing a method of FIGS. 1-4.

Referring to FIG. 6, an apparatus 600 for training an object recognition model according to an embodiment of the present disclosure may include a reception device 610, a learning device 620, and storage 630.

The storage 630 may be a means for storing pieces of data for training the object recognition model of the present disclosure. The storage 630 may store training data, the object recognition model, a loss function, an object recognition model training algorithm, or the like. However, the storage 630 may store various pieces of data associated with the technology of the present disclosure as well as the above-mentioned data.

The reception device 610 may receive training data for training the object recognition model.

The learning device 620 may train the object recognition model using a loss function including a first loss function for a class score of an object and a first weight function for reflecting confidence for the class score of the object and the training data.

In an embodiment, the first loss function may be a loss function L_{C} for an object class (or type) in Equation 1 above.

The first weight function may be a function to explicitly assign a weight to a condition the first loss function does not represent. In other words, the first weight function may be a function for supplementing that the first loss function does not represent confidence of a recognition object or a recognition target. The first weight function may increase a loss value of the loss function to a first value or more when the class score of each object by the first loss function is a uniform distribution and may decrease the loss value of the loss function to a second value or less when determining a class wrong for the object as satisfying a predetermined probability criteria (e.g., as a predetermined first probability or more).

According to an embodiment, the learning device 620 may learn confidence-based 3D location value that is not included in a conventional loss function for a 3D location of the object, such as the loss function for the 3D location of the object in Equation 1 above.

In an embodiment, the learning device 620 may learn the 3D location of the object using a loss function for the 3D location of the object. The loss function for the 3D location of the object may include a second loss function for the 3D location of the object and a second weight function for reflecting confidence for the 3D location of the object.

Although a description of the apparatus according to an embodiment of the present disclosure is omitted, the apparatus according to the embodiment of the present disclosure may include all contents described in the method of FIGS. 1-4. This should be apparent to those having ordinary skill in the art to which the present disclosure pertains.

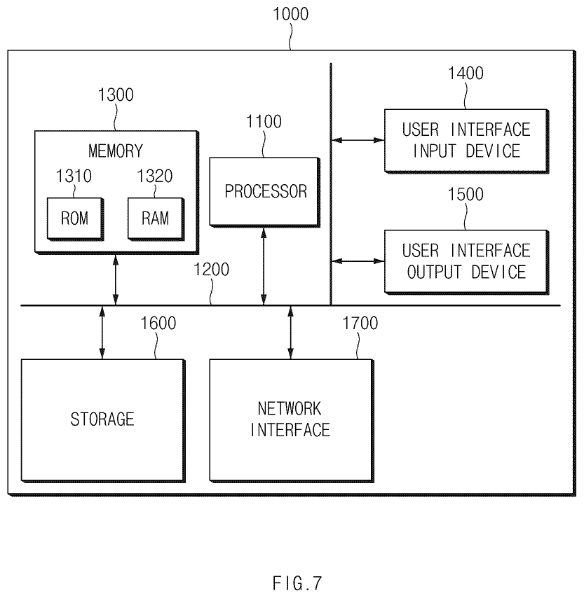

FIG. 7 illustrates a block diagram of a computing system for executing a method for training an object recognition model according to an embodiment of the present disclosure.

Referring to FIG. 7, a method for training the object recognition model according to embodiments of the present disclosure may be implemented through a computing system 1000. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the methods or algorithms described in connection with the embodiments of the present disclosure may be directly implemented with a hardware module, a software module, or a combination of the hardware module and the software module, which is executed by the processor 1100. The software module may reside on a storage medium (e.g., the memory 1300 and/or the storage 1600) such as a RAM, a flash memory, a ROM, an EPROM, an EEPROM, a register, a hard disc, a removable disk, and a CD-ROM. The storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

The above-described embodiments may be implemented with hardware components, software components, and/or a combination of hardware components and software components. For example, the devices, methods, and elements described in the embodiments of the present disclosure may be implemented by using one or more general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing unit may perform an operating system (OS) or one or software applications running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be stored in one or more computer-readable storage media.

The methods according to embodiments of the present disclosure may be recorded in computer-readable media including program instructions to implement various operations embodied by a computer. The computer-readable media may also include, alone or in combination with the program instructions, data files, data structures, and the like. The program instructions recorded in the medium may be designed and configured specially for the embodiments or be known and available to those skilled in computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like. The described hardware devices may be configured to act as one or more software modules to perform the operations of the above-described embodiments, or vice versa.

Even though the embodiments are described with reference to accompanying drawings, it should be understood by one of ordinary skill in the art that the embodiments may be variously changed or modified based on the above description without departing from the scope and spirit of the present disclosure. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

According to embodiment of the present disclosure, an apparatus for training the object recognition model may reflect confidence for a class score of an object in a loss function to train the object recognition model.

According to embodiments of the present disclosure, an apparatus for training the object recognition model may train the object recognition model using the loss function in which the confidence for the class score of the object is reflected, thus improving the accuracy of object recognition using the trained object recognition model.

According to embodiments of the present disclosure, an apparatus for training the object recognition model may train the object recognition model using a loss function in which confidence for a 3D location of the object is reflected, thus improving the accuracy of location for distance.

The effects that are achieved through the present disclosure may not be limited to the effects described above. Other advantages not described above may be more clearly understood from the foregoing detailed description by those having ordinary skill in the art to which the present disclosure pertains.

Hereinabove, although the present disclosure has been described with reference to illustrative embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims. Therefore, embodiments disclosed in the present disclosure are not intended to limit the technical spirit of the present disclosure, and the scope of the technical spirit of the present disclosure is not limited by such an embodiment. The scope of the present disclosure should be construed on the basis of the accompanying claims, and all the technical ideas within the scope equivalent to the claims should be included in the scope of the present disclosure.

What is claimed is:

1. A method for training an object recognition model, the method comprising:
receiving training data; and
training the object recognition model using a loss function that includes a first loss function for a class score of an object and a first weight function for reflecting confidence for the class score of the object and the training data.

2. The method of claim 1, wherein the first weight function is configured to:
increase a loss value of the loss function based on a determination that the class score of the object according to the first loss function is a uniform distribution; and
decrease the loss value of the loss function based on a determination that a wrong class for the object satisfies a predetermined probability criterion.

3. The method of claim 2, wherein the loss function includes a sum of the first loss function and the first weight function.

4. The method of claim 3, wherein the first weight function is represented as (1+Lₛₑ)·(1-L_{cer}), wherein
$${L}_{se} = - {\sum }_{i = 1}^{n} ( {P}_{i} \cdot {log}_{2} {P}_{i} )$$
$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$
and wherein
Pᵢ is an output value of the object recognition model for all classes of a target object,
wᵢ is a predetermined weight, and
C_{gt} is a ground-truth class.

5. The method of claim 1, wherein the loss function further includes a second loss function for a three-dimensional (3D) location of the object and a second weight function for reflecting confidence for the 3D location of the object.

6. The method of claim 5, wherein the loss function includes a sum of the second weight function and the second loss function represented by (L_{uc_xz}+L_{uc_vl}+L_{uc_a})|, wherein
$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$
$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$
$${D}_{pg} = \frac{1}{1 + exp ( - ( p - g ) )}$$
$$U = ( ( 1 + {L}_{se} ) \cdot ( 1 - {L}_{cer} ) )$$
$${L}_{se} = - {\sum }_{i = 1}^{n} ( {P}_{i} \cdot {log}_{2} {P}_{i} )$$
$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$
$${N}_{max} = max ( 1 , N ( {D}_{pg} \vert 0.5 , U ) )$$
wherein
Pᵢ is an output value of the object recognition model for all classes of a target object,
wᵢ is a predetermined weight,
C_{gt} is a ground-truth class,
p (x) and p (z) are an estimated x-coordinate value and an estimated z-coordinate value of the object, respectively,
g (x) and g (z) are a ground-truth x-coordinate value and a ground-truth z-coordinate value of the object, respectively,
p (l) and p (a) are an estimated volume value and an estimated heading angle of the object, respectively, and
g(l) and g (a) refer to a ground-truth volume value and a ground-truth heading angle of the object, respectively.

7. An object recognition method comprising:
receiving an input image; and
recognizing at least one object included in the input image using an object recognition model trained by a loss function that includes a first loss function for a class score of an object and a first weight function for reflecting confidence for the class score of the object.

8. The object recognition method of claim 7, wherein the first weight function is configured to:
increase a loss value of the loss function based on a determination that the class score of the object by the first loss function is a uniform distribution; and
decrease the loss value of the loss function based on a determination that a class that is wrong for the object satisfies a predetermined probability criterion.

9. The object recognition method of claim 8, wherein the first weight function is represented as (1+Lₛₑ)·(1-L_{cer}), wherein
$${L}_{se} = - {\sum }_{i = 1}^{n} ( {P}_{i} \cdot {log}_{2} {P}_{i} )$$
$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$
and wherein
Pᵢ is an output value of the object recognition model for all classes of a target object,
wᵢ is a predetermined weight, and
C_{gt} is a ground-truth class.

10. The object recognition method of claim 7, wherein the loss function further includes a second loss function for a 3D location of the object and a second weight function for reflecting confidence for the 3D location of the object.

11. The object recognition method of claim 10, wherein the loss function includes a sum of second weight function and the second loss function represented as (L_{uc_xz}+L_{uc_vl}+L_{uc_a}), wherein
$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$
$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$
$${D}_{pg} = \frac{1}{1 + exp ( - ( p - g ) )}$$
$$U = ( ( 1 + {L}_{se} ) \cdot ( 1 - {L}_{cer} ) )$$
$${L}_{se} = - {\sum }_{i = 1}^{n} ( {P}_{i} \cdot {log}_{2} {P}_{i} )$$
$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$
$${N}_{max} = max ( 1 , N ( {D}_{pg} \vert 0.5 , U ) )$$
and wherein
Pᵢ is an output value of the object recognition model for all classes of a target object,
wᵢ is a predetermined weight,
C_{gt} is a ground-truth class,
p (x) and p (z) are an estimated x-coordinate value and an estimated z-coordinate value of the object, respectively,
g (x) and g (z) are a ground-truth x-coordinate value and a ground-truth z-coordinate value of the object, respectively,
p (l) and p (a) are an estimated volume value and an estimated heading angle of the object, respectively,
and g(l) and g (a) are a ground-truth volume value and a ground-truth heading angle of the object, respectively.

12. An apparatus for training an object recognition model, the apparatus comprising:
a memory storing computer-readable instructions; and
at least one processor coupled to the memory and configured to execute the computer-readable instructions,
wherein the at least one processor is configured to
receive training data, and
train the object recognition model using a loss function that includes a first loss function for a class score of an object and a first weight function for reflecting confidence for the class score of the object and the training data.

13. The apparatus of claim 12, wherein the first weight function is configured to:
increase a loss value of the loss function based on a determination that the class score of the object by the first loss function is a uniform distribution; and
decrease the loss value of the loss function based on a determination that a class wrong for the object satisfies a predetermined probability criterion.

14. The apparatus of claim 13, wherein the loss function includes a sum of the first loss function and the first weight function.

15. The apparatus of claim 14, wherein the first weight function is represented as (1+Lₛₑ)·(1-L_{cer}), wherein,
$${L}_{se} = - {\sum }_{i = 1}^{n} ( {P}_{i} \cdot {log}_{2} {P}_{i} )$$
$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$
and wherein
Pᵢ is an output value of the object recognition model for all classes of a target object,
wᵢ is a predetermined weight, and
C_{gt} is a ground-truth class.

16. The apparatus of claim 12, wherein the loss function further includes a second loss function for a 3D location of the object and a second weight function for reflecting confidence for the 3D location of the object.

17. The apparatus of claim 16, wherein the loss function includes a sum of the second weight function and the second loss function represented as (L_{uc_xz}+L_{uc_vl}+L_{uc_a}), wherein
$${L}_{uc \_ xz} = - log ( \frac{N ( {D}_{p ( x ) g ( x )} \vert 0.5 , U )}{{N}_{max}} ) - log ( \frac{N ( {D}_{p ( z ) g ( z )} \vert 0.5 , U )}{{N}_{max}} )$$
$${L}_{uc \_ vl} = - log ( \frac{N ( {D}_{p ( l ) g ( l )} \vert 0.5 , U )}{{N}_{max}} ) , {L}_{uc \_ a} = - log ( \frac{N ( {D}_{p ( a ) g ( a )} \vert 0.5 , U )}{{N}_{max}} )$$
$${D}_{pg} = \frac{1}{1 + exp ( - ( p - g ) )}$$
$$U = ( ( 1 + {L}_{se} ) \cdot ( 1 - {L}_{cer} ) )$$
$${L}_{se} = - {\sum }_{i = 1}^{n} ( {P}_{i} \cdot {log}_{2} {P}_{i} )$$
$${L}_{cer} = {\sum }_{i = 1}^{n} ( {w}_{i} \cdot {P}_{i} ) , {w}_{i} = \{ \begin{matrix}1 & , i = {C}_{gt} \\ 0 & , else\end{matrix}$$
$${N}_{max} = max ( 1 , N ( {D}_{pg} \vert 0.5 , U ) )$$
and wherein
Pᵢ is an output value of the object recognition model for all classes of a target object,
wᵢ is a predetermined weight,
C_{gt} is a ground-truth class,
p (x) and p (z) are an estimated x-coordinate value and an estimated z-coordinate value of the object, respectively,
g (x) and g (z) are a ground-truth x-coordinate value and a ground-truth z-coordinate value of the object, respectively,
p (l) and p (a) are an estimated volume value and an estimated heading angle of the object, respectively, and
g(l) and g (a) refer to a ground-truth volume value and a ground-truth heading angle of the object, respectively.
